(19) United States
(12) Patent Application Publication
(10) Pub. No.: US 2026/0050959 A1
(43) Pub. Date: Feb. 19, 2026

(54) MEDICAL VOICE COMMERCE SYSTEM WITH ARTIFICIAL INTELLIGENCE FOR HEALTHCARE INTEGRATION AND UNIVERSAL ACCESSIBILITY

(71) Applicant: Stephen M. Byrd, Upper Marlboro, MD (US)

(72) Inventor: Stephen M. Byrd, Upper Marlboro, MD (US)

(21) Appl. No.: 19/301,951

(22) Filed: Aug. 16, 2025

Related U.S. Application Data
(63) Continuation-in-part of application No. 16/823,370, filed on Mar. 19, 2020, now abandoned.
(63) Continuation-in-part of application No. 17/408,858, filed on Aug. 23, 2021, now abandoned.

(51) Int. Cl. G06Q 30/0601

(52) U.S. Cl. CPC G06Q 30/0624

(57) ABSTRACT

The invention discloses a multilingual medical voice commerce system enabling secure, voice-activated transactions for healthcare products, services, and prescriptions. Utilizing AI-driven speech recognition optimized for medical terminology, the system integrates natural language processing and context-aware recommendation engines. Secure features include HIPAA-compliant authentication, patient consent management, and end-to-end encryption. The platform interfaces with electronic health records, pharmacy networks, insurance verification systems, and wearable health monitors for real-time medical data access and transaction execution. Designed for hospital procurement, surgical environments, telehealth, and home healthcare, the system incorporates universal accessibility, including adaptations for visual, motor, cognitive, and speech impairments. Multilingual capabilities ensure cultural and linguistic inclusivity. AI analytics track usage patterns, optimize recommendations, detect health trends, and support population health initiatives. Operable across smart speakers, medical devices, and connected platforms, the system delivers a unified, monetized, secure, and inclusive medical voice commerce ecosystem for patients, providers, and healthcare organizations worldwide.

### CROSS REFERENCE TO RELATED APPLICATIONS

The present application is a Continuation-In-Part application of U.S. patent application Ser. No. 16/823,370 filed on 19 Mar. 2020, and patent application Ser. No. 17/408,858 filed on 23 Aug. 2021, which are herein incorporated in their entirety.

### FIELD OF THE DISCLOSURE

The present disclosure relates to voice-activated commerce in the healthcare sector, and more particularly to a multilingual, AI-driven medical voice commerce system with universal accessibility. The invention enables secure, voice-based transactions for medical products, prescriptions, and healthcare services, integrating with electronic health records, pharmacy systems, insurance platforms, and connected medical devices. It further includes speech recognition optimized for medical terminology, natural language processing, and accessibility features for users with visual, motor, cognitive, or speech impairments.

### BACKGROUND OF THE RELATED ART

Voice-activated technologies have become increasingly common in consumer electronics, enabling users to perform searches, control devices, and make purchases through spoken commands. While such systems have been adapted for general e-commerce, their application in healthcare commerce remains limited. Existing platforms often lack integration with critical healthcare infrastructure such as electronic health records, pharmacy networks, insurance verification systems, and medical device data streams. Furthermore, many voice systems are monolingual and fail to address the accessibility needs of individuals with visual, motor, cognitive, or speech impairments.

In medical environments, where accuracy, security, and compliance are paramount, current solutions do not provide sufficient safeguards for patient privacy or medical data handling, nor do they offer context-aware recommendations tailored to medical terminology. As a result, there exists a need for a multilingual, AI-driven medical voice commerce platform that integrates with healthcare systems, ensures universal accessibility, and complies with industry regulations.

### DESCRIPTION OF RELATED ARTS

US granted patent, U.S. Ser. No. 10/984,128B1 discloses a system for upgrading communication networks to provide personalized, rapid healthcare support. The system integrates biometric identification, such as fingerprints or facial recognition, into network infrastructure or connected resources, linking biometric and location data to enable always-on emergency connectivity, even during roaming, while safeguarding raw biometric and sensitive health information. Using “Push to Blink” biometric-linked identifiers matched to network keys, it delivers urgency-based healthcare services. The system supports 2G, 3G, 4G, and other networks, operates over visited operator IP services, and facilitates mission-critical communications with intermodal content during healthcare support sessions.

‘James F. Kragh et al.’ in a US granted patent U.S. Ser. No. 9/805,213B1, discloses a system for verifying and validating user identity to access a secure personal dataset containing identifiable attributes. The system uses biometric identifiers to confirm identity, generates a digital security element, and provides the user with a password and unique electronic address for secure access. It maintains an electronic audit trail and supports access through devices such as smartphones, tablets, and computers, enabling retrieval of authenticated data, including Emergency Medical and Contact information.

In yet another patent application, bearing application number U.S. Ser. No. 10/811,123B2, David et al. Discloses a system and method for capturing and managing one or more voice files containing speech utterances (“Voice Utterances”) and/or corresponding transcripts (“Transcripts”). These voice files and transcripts can be stored, organized, and utilized for various applications requiring recorded speech and its textual representation.

Another granted patent, international application No. PCT/US2016/057086 discloses a system and method for securely storing preexisting medical and personal information, accessible in real time by emergency workers via a mobile application. The application uses facial recognition to match a casualty's image with a master image of the participant, providing identity verification. Once identified, stored medical and demographic data are transmitted to emergency responders to assist in providing appropriate care.

None of the above discussed prior arts teaches a multilingual, AI-enabled medical voice commerce system specifically designed to integrate healthcare services with secure voice transactions, personalized medical data access, and universal accessibility features. The disclosed system uniquely combines real-time voice interaction, AI-driven healthcare integration, and e-commerce capabilities to facilitate secure medical purchases, service bookings, and patient support across multiple platforms and devices.

### SUMMARY OF THE INVENTION

The present invention introduces a multilingual, AI-driven medical voice commerce system designed to securely facilitate healthcare-related transactions and service interactions through natural spoken commands. The system bridges the gap between modern voice technology and the unique demands of the healthcare sector by integrating with critical medical infrastructure and enabling users to access, manage, and purchase healthcare products, prescriptions, and services in a secure, accessible, and user-friendly manner.

In some embodiments, the system may be configured to interface with electronic health record (EHR) systems, pharmacy management networks, insurance verification systems, and connected medical devices. Embodiments may also be configured to enable real-time retrieval and processing of patient data. Embodiments may further be configured to provide context-aware recommendations, validate transactions against medical eligibility criteria, and ensure that purchases or service requests align with a patient's clinical needs and coverage status.

In some embodiments, the system may include a speech recognition engine optimized for medical terminology, abbreviations, and drug names in multiple languages. Embodiments may further include multilingual processing capabilities configured to recognize regional dialects and localized medical expressions to ensure accuracy across diverse populations. Embodiments may also include natural language processing (NLP) modules configured to interpret user intent in complex or colloquial speech patterns and to map commands to corresponding system actions without reliance on predefined command structures.

In some embodiments, the system may be configured to provide universal accessibility features. Embodiments may include assistive functionality for users with visual impairments, including audio-only interaction modes and high-contrast companion interfaces. Embodiments may further include assistive functionality for users with motor impairments, including fully hands-free operation. Embodiments may also include assistive functionality for users with cognitive impairments, including simplified command options and step-by-step guided interactions. Embodiments may additionally include assistive functionality for users with speech impairments, including adaptive speech recognition models and alternative input pathways.

In some embodiments, the system may include artificial intelligence analytics configured to continuously monitor user activity and interaction patterns. Embodiments may further be configured to detect healthcare needs, identify trends in treatment adherence, and generate predictive insights. Embodiments may also be configured to use such insights to personalize recommendations, including refill reminders, preventive screenings, or alternative treatments, based on medically verified data.

In some embodiments, the system may be configured to provide security and regulatory compliance through multiple layers of protection. Embodiments may include HIPAA-compliant authentication mechanisms, encrypted data transmission, user consent management, and transaction logging for auditability. Embodiments may further include biometric authentication methods, including voiceprint recognition, configured to enhance security while maintaining ease of use.

In some embodiments, the system may be configured to support a tiered access structure. Embodiments may allow different types of users, including patients, caregivers, clinicians, pharmacists, and insurers, to access only information and functionality appropriate to their respective roles. Embodiments may further be configured to ensure that sensitive patient data is disclosed solely to authorized parties while enabling efficient coordination of care and transactions.

In some embodiments, the system may operate as a standalone voice assistant device configured for medical use. In other embodiments, the system may be integrated into smart speakers, smartphones, or healthcare facility systems. Embodiments may further be configured to operate within virtual or augmented reality environments to enable immersive and interactive healthcare commerce experiences, including three-dimensional product demonstrations and simulated consultations.

In some embodiments, the system may include a commerce engine configured to be strategy-aware. Embodiments may be configured to automatically adjust recommendations and purchasing workflows based on insurance coverage changes, updated treatment guidelines, or evolving patient health conditions. Embodiments may further be configured to support promotional and discount structures in compliance with healthcare marketing regulations to ensure that incentives do not conflict with ethical or legal constraints.

In some embodiments, the system may be configured for multilingual deployment. Embodiments may be configured to dynamically adjust both recognition and output language based on user preference, location, or patient profile. Embodiments may further be configured to seamlessly switch between languages within a single session, thereby enabling caregivers and medical staff to interact effectively with patients from diverse linguistic backgrounds.

In some embodiments, the system may include an eligibility and compliance verification module configured to operate in real time during voice interactions. Embodiments may be configured to ensure that purchases, service requests, and transactions adhere to applicable medical guidelines, insurance policy terms, and jurisdictional regulations prior to processing.

In some embodiments, the system may be configured for integration with telehealth platforms. Embodiments may be configured to facilitate voice-based appointment scheduling, initiate remote consultations, and transmit pre-visit information directly to healthcare providers. Embodiments may further be configured to create a streamlined end-to-end patient experience by reducing friction between medical advice, prescription issuance, and product procurement.

In some embodiments, the system may be configured to execute voice commerce bundles. Embodiments may be configured to enable multiple related products or services to be purchased in a single transaction based on a recognized healthcare event or need. Embodiments may further be configured to facilitate, for example, a post-operative care bundle including wound dressings, pain management medication, and physical therapy appointments, all arranged through a single spoken request.

In some embodiments, the system may be configured to provide offline functionality for critical tasks. Embodiments may be configured to allow users to access stored medical information, view transaction history, or generate reminders without an active network connection. Embodiments may further be configured to synchronize all offline actions with the main system once connectivity is restored.

In some embodiments, the system may include an artificial intelligence engine configured to be trained using medically verified datasets. Embodiments may be further configured to continuously update the AI engine to reflect evolving clinical guidelines, drug formularies, and healthcare product availability. Embodiments may also be configured to ensure that recommendations remain current, evidence-based, and compliant with the latest industry standards.

In some embodiments, the system is equipped with environmental awareness capabilities, enabling it to adjust its interaction style and content delivery based on ambient noise levels, proximity to the user, or presence of multiple speakers.

In some embodiments, the system may be configured for deployment in multiple settings, including hospitals, pharmacies, elder care facilities, and private homes. Embodiments may further be configured to enable effective interaction by both healthcare professionals and laypersons.

In some embodiments, the system may be configured to assist healthcare providers in ordering medical supplies, verifying insurance coverage for procedures, and managing inventory through voice commands.

In some embodiments, the system may be configured to support public health applications. Embodiments may be configured to aggregate and anonymize user data to inform policy-making, detect regional health trends, and support early detection of disease outbreaks without compromising individual privacy.

In some embodiments, the system may be configured with a modular architecture. Embodiments may be further configured to allow the addition of new capabilities, including integration with emerging medical devices, adoption of new languages, or expansion into new commerce categories, without requiring major system overhauls.

In some embodiments, the system may be configured to facilitate voice-enabled payments. Embodiments may be configured to support payments for healthcare products, health insurance premiums, membership fees for health programs, or co-payments for services, thereby creating a unified payment experience.

In some embodiments, the system may include text-to-speech and speech-to-text engines configured for multilingual deployment. Embodiments may be further configured to ensure culturally appropriate phrasing and tone to enhance user trust and adoption.

In some embodiments, the system may be configured with a robust accessibility framework. Embodiments may be further configured to ensure compliance with applicable accessibility laws and standards, including the Americans with Disabilities Act (ADA) and WCAG guidelines, where relevant.

In some embodiments, the system may be configured to combine multilingual AI speech technology, secure commerce workflows, healthcare system integration, and universal accessibility. Embodiments may be further configured to address unmet needs in medical commerce and create a new paradigm for patient engagement.

In some embodiments, the system may be configured to evolve alongside advancements in artificial intelligence, healthcare policy, and voice technology. Embodiments may be further configured to ensure long-term relevance and adaptability in a rapidly changing technological landscape.

In some embodiments, the system may be configured to overcome limitations of existing voice commerce systems. Embodiments may be further configured to deliver a specialized, secure, multilingual, and universally accessible solution specifically tailored for the complexities of healthcare transactions.

In some embodiments, the system may be configured to provide an integrated, intelligent, and inclusive approach. Embodiments may be further configured to improve access, efficiency, and personalization in healthcare transactions worldwide, thereby representing a transformative advancement in medical voice commerce.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a block diagram illustrating a medical voice commerce system architecture, according to some embodiments of the present disclosure.

FIG. 2 is a block diagram further illustrating the integration of the multilingual AI-driven voice interface with healthcare databases, medical device APIs, and e-commerce platforms, according to some embodiments of the present disclosure.

FIG. 3 is a block diagram illustrating the system's accessibility module, including adaptive input/output components for users with disabilities, according to some embodiments of the present disclosure.

FIG. 4 is a block diagram illustrating the AI analytics and recommendation engine for healthcare commerce, according to some embodiments of the present disclosure.

FIG. 5 is a flowchart illustrating a method for processing a multilingual medical voice commerce request from initial speech capture to transaction completion, according to some embodiments of the present disclosure.

FIG. 6 is a flowchart further illustrating the compliance verification and regulatory checks performed during the medical voice commerce process, according to some embodiments of the present disclosure.

FIG. 7 is a flowchart illustrating the accessibility-driven interaction process for visually impaired or physically limited users, according to some embodiments of the present disclosure.

FIG. 8 is a diagram illustrating an example deployment of the system within a healthcare facility, integrating with patient rooms, nurse stations, and pharmacy kiosks, according to some embodiments of the present disclosure.

FIG. 9 is a diagram illustrating an example deployment of the system in a home healthcare environment, integrated with wearable medical devices, smart assistants, and remote monitoring services, according to some embodiments of the present disclosure.

FIG. 10 is a sequence diagram illustrating order and fulfillment interactions, according to some embodiments of the present disclosure.

FIG. 11 is a block diagram illustrating deployment and security architecture, according to some embodiments of the present disclosure.

### DETAILED DESCRIPTION OF THE INVENTION

Unless otherwise defined, all technical terms used herein related to medical voice commerce, AI-driven healthcare integration, multilingual speech recognition, assistive accessibility technologies, and secure digital transactions have the same meaning as commonly understood by one of ordinary skill in the relevant arts of healthcare informatics, natural language processing, machine learning, speech-to-text systems, and electronic commerce. Terms such as “medical voice commerce,” “healthcare integration,” “multilingual processing,” “AI-driven personalization,” “universal accessibility,” and “assistive interface” should be interpreted as having meanings consistent with their usage in the context of this specification and the current state of intelligent healthcare and e-commerce technologies. These terms should not be interpreted in an idealized or overly formal sense unless expressly defined herein. For brevity and clarity, well-known functions or constructions related to AI model training, speech recognition pipelines, electronic health record (EHR) interoperability, and secure payment gateways may not be described in detail.

The terminology used herein describes particular embodiments of the medical voice commerce system and is not intended to be limiting. As used herein, singular forms such as “a multilingual voice interface,” “a healthcare integration module,” and “an accessibility engine” are intended to include plural forms as well, unless the context clearly indicates otherwise. Similarly, references to “voice input,” “healthcare transaction,” or “commerce request” should be understood to include multiple instances, versions, or iterations of such elements, where applicable.

With reference to the use of the words “comprise” or “comprises” or “comprising” in describing the components, processes, or functionalities of the medical voice commerce system, and in the following claims, unless the context requires otherwise, these words are used on the basis and clear understanding that they are to be interpreted inclusively rather than exclusively. For example, when referring to “comprising a healthcare integration module,” the term should be understood to mean including but not limited to the described integration capabilities, and may include additional modules or functionalities not explicitly described. Each instance of these words is to be interpreted inclusively in construing the description and claims, particularly in relation to the system's modular and scalable architecture.

Furthermore, terms such as “connected,” “coupled,” “linked,” or “in communication with” as used in describing the interaction between various modules of the system (such as between the multilingual voice processing engine and the EHR interface) should be interpreted to include both direct connections and indirect connections through one or more intermediary components, unless explicitly stated otherwise. References to “processing,” “analyzing,” “translating,” “executing,” or “delivering” should be understood to encompass both real-time operations and delayed or batch processing, unless specifically limited to one or the other in the context.

In some embodiments, the invention provides a Medical Voice Commerce System with AI-Driven Healthcare Integration and Universal Accessibility that operates as a unified, intelligent platform enabling secure, multilingual, and context-aware voice transactions in clinical, telehealth, pharmacy, and emergency medical environments. The system may be configured to capture natural language speech from a patient, caregiver, or clinician; interpret that input using multilingual natural language processing (NLP) models; match the request to healthcare records; determine transaction eligibility; and execute secure commercial activities such as purchasing medical supplies, paying service fees, or processing insurance claims. The platform may also incorporate adaptive accessibility features, ensuring that individuals with visual, hearing, motor, or cognitive impairments can access all functionalities without loss of capability. In some embodiments, all modules are implemented in a cloud-based architecture to allow elastic scalability and global accessibility, while in other embodiments, the system may be deployed on-premises within a hospital network for enhanced data control.

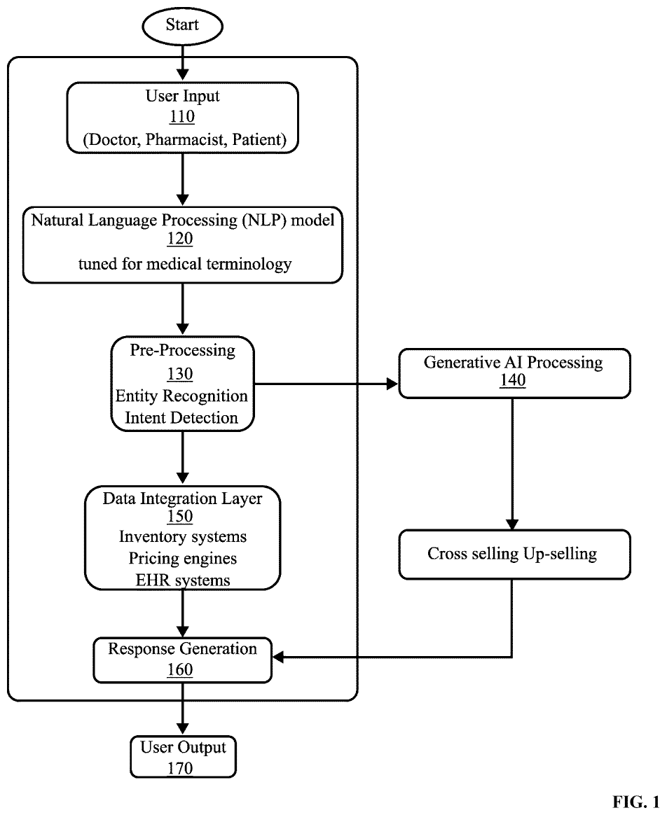

In certain embodiments, and with reference to FIG. 1, the system comprises a multilingual voice interface 110 configured to detect over 100 spoken languages and dialects; an AI-driven healthcare integration module 120 for retrieving and updating patient-specific records from one or more electronic health record (EHR) systems; a commerce transaction engine 130 for executing secure healthcare-related purchases; a universal accessibility layer 140 for tailoring the interface to user-specific needs; and a secure communications framework 150 for ensuring data confidentiality and integrity. These core modules may be interconnected through an API gateway 160 that enforces authentication, rate-limiting, and protocol standardization when communicating with external services such as insurance verification platforms, medical supplier databases, or regulatory compliance systems.

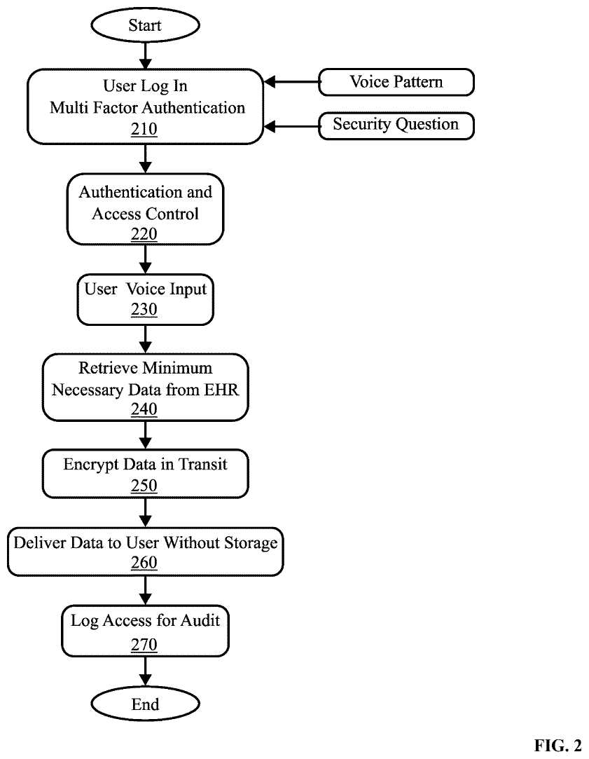

In some embodiments, and as shown in FIG. 2, the system initiates an interaction at Initial State 210, where the user issues a spoken request through a microphone-enabled device such as a smartphone, smart speaker, or telehealth terminal. The Automatic Speech Recognition (ASR) subsystem processes the input, detecting both the language and acoustic profile of the speaker, and routes the transcribed text into the NLP module for intent extraction 220. At this stage, the NLP may employ medical ontologies and terminology mapping to ensure that clinical vocabulary is interpreted correctly. The output is a structured, machine-readable command that is passed to the healthcare integration module 230, which interfaces with EHR databases, lab results systems, or medical imaging repositories to contextualize the request before initiating any commercial or scheduling actions.

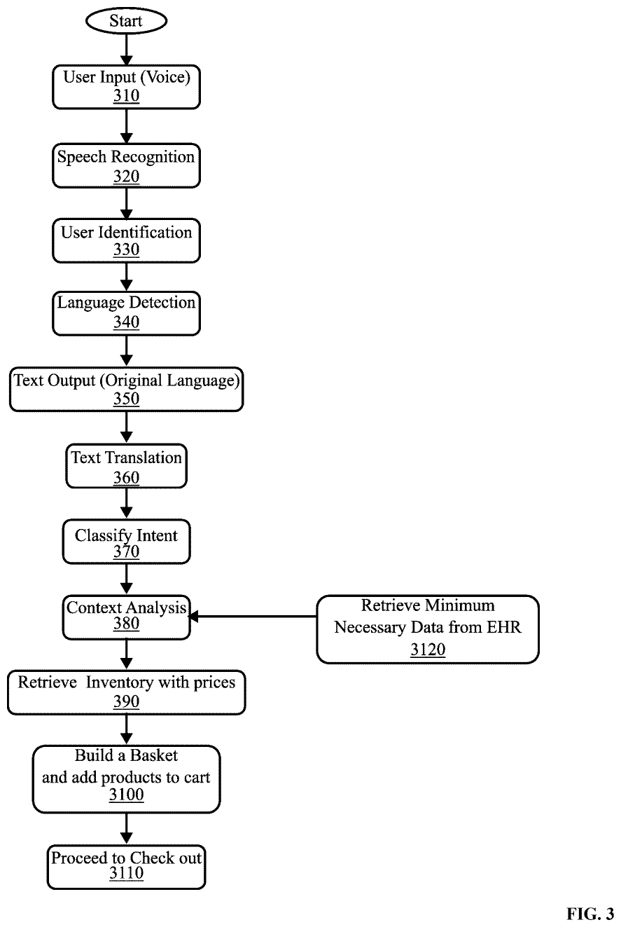

In certain embodiments, FIG. 3 illustrates that the healthcare integration process begins with patient verification 310 through biometric checks, multi-factor authentication, or matching government-issued identifiers against stored EHR data. Once verified, the system proceeds to eligibility determination 315, checking insurance coverage, prescription validity, or service availability. If the requested action involves a prescription refill, the prescription validation step 320 may include querying regulatory drug databases to ensure compliance with controlled substance laws. Finally, service scheduling 325 may be initiated to book appointments with specialists or coordinate delivery of medical equipment. At each of these steps, audit logs are generated for compliance tracking.

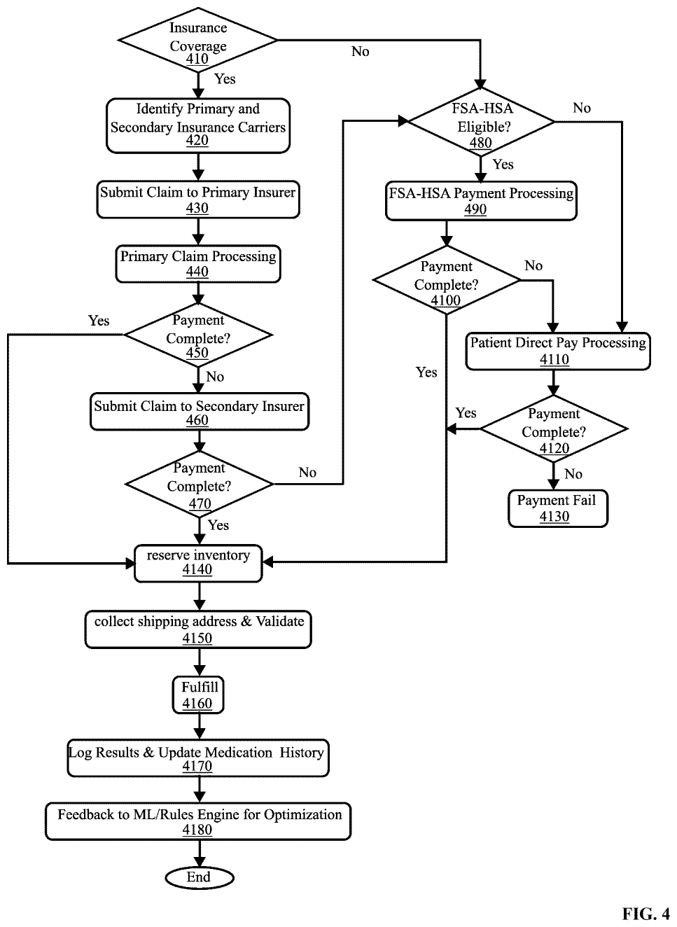

In some embodiments, and with reference to FIG. 4, when the process transitions to the commerce transaction engine, multi-step order placement 410 is performed by matching the requested medical product or service to one or more supplier inventories. Payment processing 415 may involve integration with PCI-DSS-compliant gateways, enabling secure credit card, mobile payment, or direct insurance billing. Fulfillment coordination 420 may automatically select the fastest delivery route based on geolocation data and urgency of the medical need. In certain implementations, blockchain-based logging 425 is used to create immutable records of each commercial action, ensuring that disputes can be resolved with verifiable evidence.

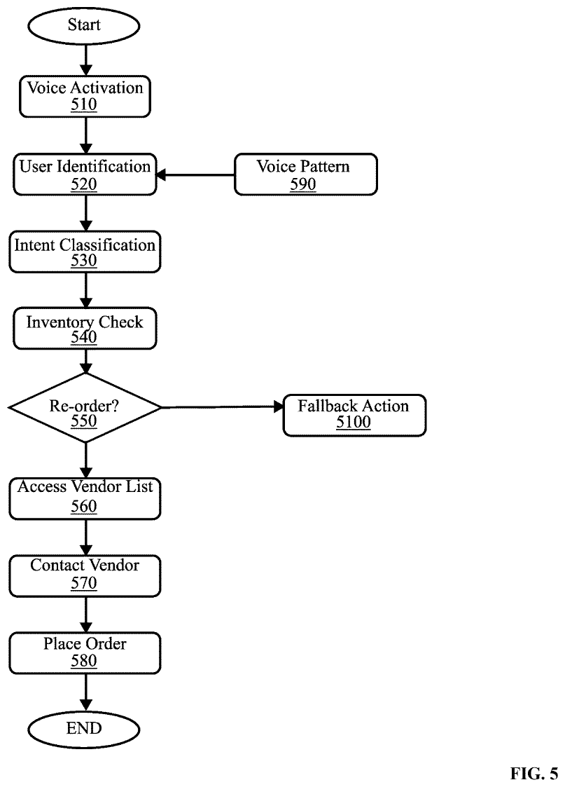

In some embodiments, FIG. 5 depicts the universal accessibility framework, which can detect the user's accessibility profile from stored settings or infer it dynamically through interaction. Adaptive voice navigation 510 may modify prompts for users with hearing impairments, speech-to-text 515 ensures that spoken system responses are also displayed on-screen, text-to-speech 520 provides synthesized voice for text outputs, and screen-reader compatibility 525 ensures all content can be read by third-party assistive software.

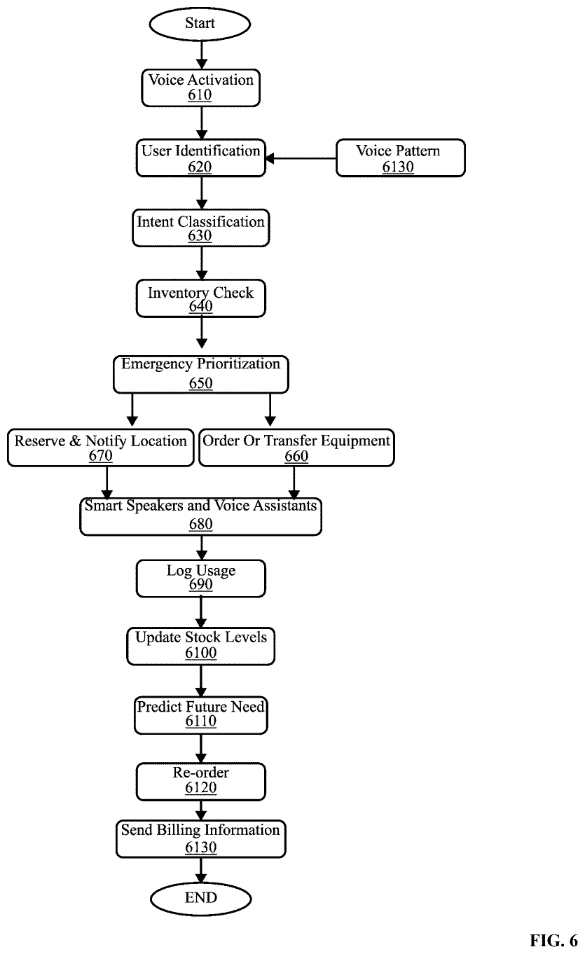

In certain embodiments, and as illustrated in FIG. 6, the multilingual support engine enables real-time translation 610 between any two supported languages, preserving domain-specific medical terminology through AI translation models 615 trained on healthcare datasets. For telehealth sessions, the system can also produce real-time subtitle generation 620, ensuring that consultations between speakers of different languages are conducted without loss of critical medical meaning.

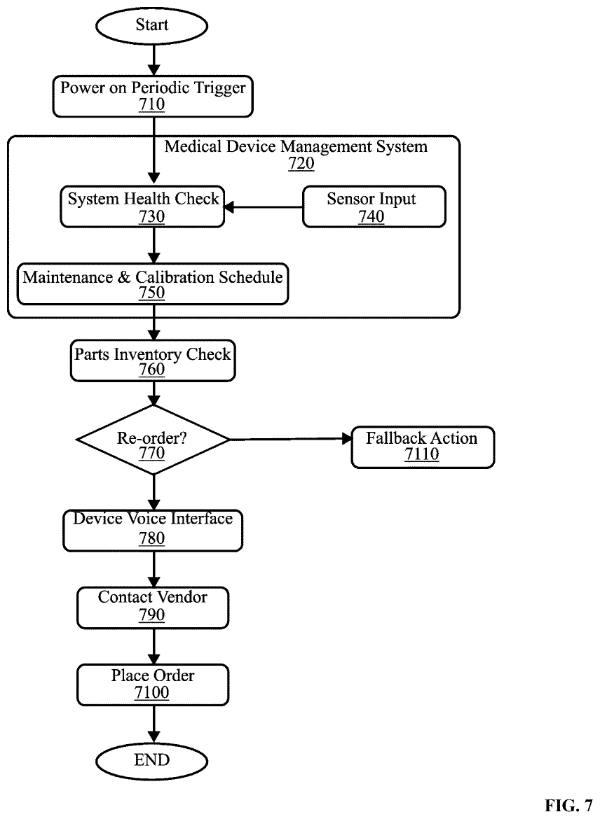

In some embodiments, FIG. 7 shows the AI recommendation engine, which aggregates patient history, lifestyle data, and prior transaction records to generate proactive, personalized suggestions 710. For instance, if a patient regularly orders diabetic testing strips, the engine might recommend compatible glucose meters or highlight new treatment options in line with current clinical guidelines.

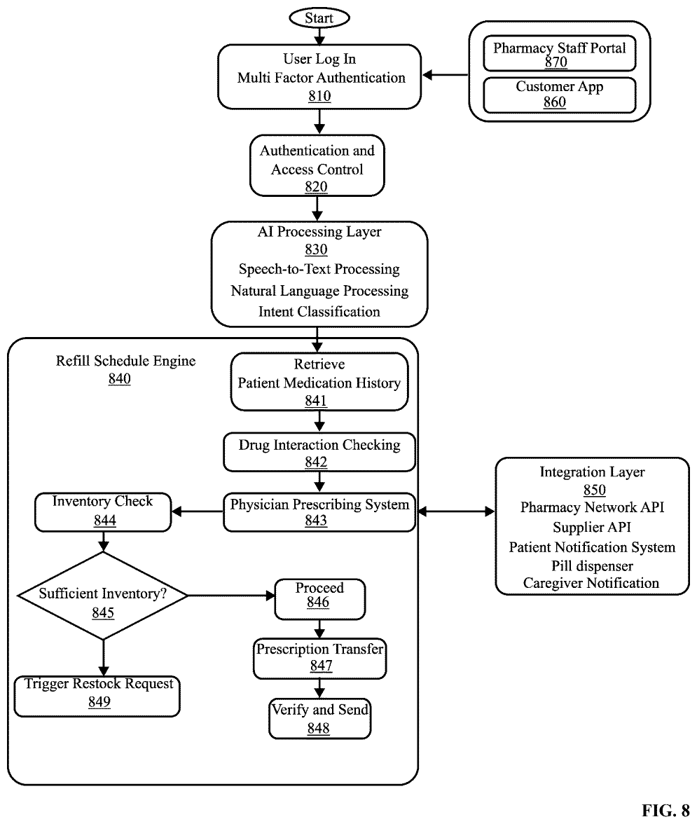

In certain embodiments, FIG. 8 outlines the operational workflow in which multilingual voice input 810 is followed by healthcare verification 820, AI-based personalization 830, and transaction execution 840. Security checkpoints 850 are positioned between these stages, implementing identity confirmation and encryption to prevent unauthorized access to medical or financial data.

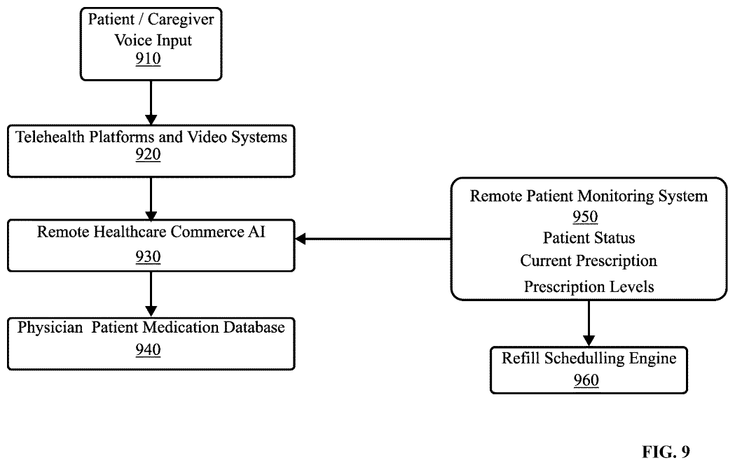

In some embodiments, and as depicted in FIG. 9, the secure data handling subsystem encrypts voice command audio streams 910, sensitive EHR data 915, and payment transaction payloads 920 using advanced encryption standards. Key management services 925 oversee cryptographic key distribution, renewal, and revocation to minimize the risk of compromise.

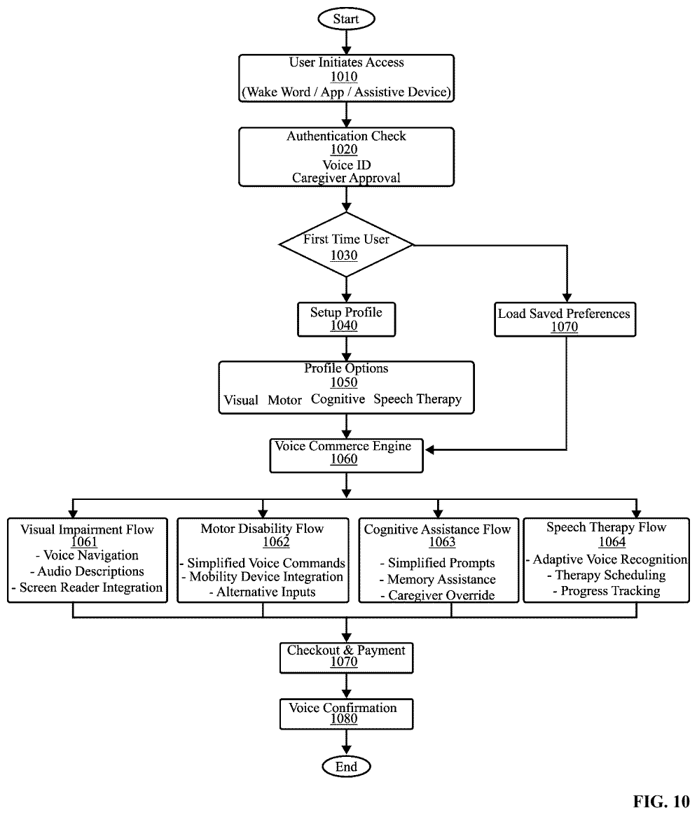

In certain embodiments, FIG. 10 illustrates the order and fulfillment model, wherein the system sends structured order requests to healthcare providers 1010, pharmacies 1020, and payment gateways 1030. Status updates 1040 may be streamed back to the user in real time, while exception handling routines 1050 can automatically offer alternative suppliers if fulfillment delays are detected.

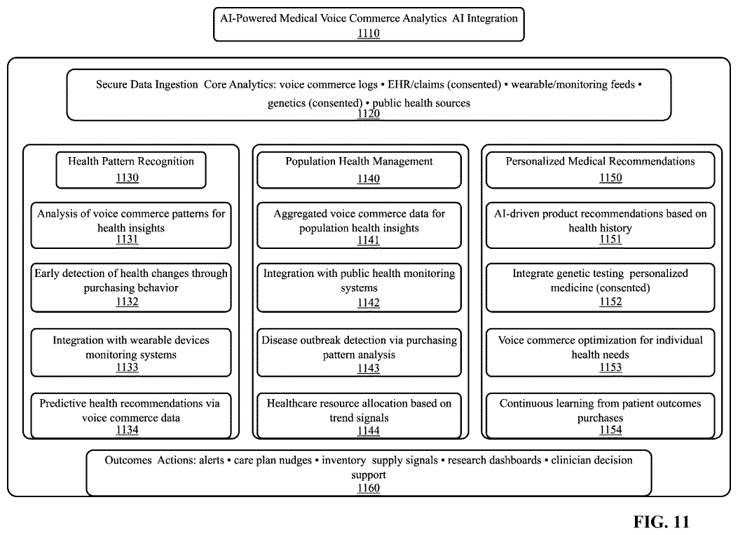

In some embodiments, FIG. 11 depicts the deployment and security architecture, supporting configurations such as public cloud, hybrid cloud, or fully on-premise hosting 1110. Layered security defenses 1120 include network segmentation, intrusion prevention systems, and zero-trust authentication models. Compliance monitoring modules 1130 continuously assess the system against regulatory standards such as HIPAA, GDPR, and ISO 27001, automatically generating reports for auditors.

In one example scenario, a visually impaired user issues a medication refill request in Swahili. The system detects and transcribes the voice input 110, translates it into English 610, verifies the prescription against EHR records 310, places an order with a preferred pharmacy 410, processes payment 415, and confirms delivery using adaptive text-to-speech navigation 520.

In another embodiment, a Spanish-speaking patient engages in a telehealth consultation with an English-speaking physician, during which the multilingual engine 610 provides simultaneous bidirectional translation and the subtitle generation module 620 displays each statement in the listener's preferred language without delay.

In yet another embodiment, during a disaster relief operation, healthcare workers in remote clinics use the system in hands-free mode to order emergency supplies. The AI recommendation engine 710 suggests equivalent medical products if primary suppliers are unavailable, while fulfillment coordination 420 optimizes delivery routes under crisis conditions.

In some embodiments, blockchain transaction logs 425 are redundantly stored in geographically distributed secure databases, allowing forensic analysis of all commercial actions without exposing protected health information.

In certain embodiments, the system's modular design enables deployment across diverse environments, from small private practices to national healthcare systems, scaling automatically in cloud-hosted modes 1110 or functioning securely within isolated hospital networks.

In some embodiments, the accessibility layer 140 integrates with third-party assistive hardware such as Braille output devices or haptic alert wristbands, enabling full participation in voice commerce workflows by users with multiple disabilities.

In certain embodiments, the multilingual voice interface supports on-the-fly language switching, allowing a clinician to speak alternately in English and French while the system maintains context without reinitializing the session.

In some embodiments, embedded AI analytics continuously evaluate system accuracy, flagging errors in voice recognition or translation for human review, and automatically retraining language models on anonymized data to improve long-term performance.

While the present disclosure describes embodiments in the field of medical voice commerce, the same core architecture may be adapted to other regulated industries such as legal services, government administration, or financial compliance, provided similar requirements for multilingual support, accessibility, and secure transactions are present. The modular and scalable nature of the system enables its adaptation without departing from the scope of the claims.

What is claimed is:

1. A computer-implemented method for multilingual medical voice commerce, comprising:
receiving a spoken request from a user in a first language via a voice interface;
processing the spoken request using a natural language processing engine to determine at least one medical-related product or service;
retrieving, from a medical commerce database, product or service data associated with the request;
presenting the product or service data to the user in a language selected by the user;
receiving a spoken confirmation from the user to complete a transaction;
executing the transaction through a secure transaction engine; and
providing an accessibility-adapted confirmation of the completed transaction to the user.

2. The method of claim 1, wherein the spoken request further comprises a request for a medical consultation.

3. The method of claim 1, wherein the natural language processing engine supports speech-to-text and text-to-speech conversion in multiple languages, and presenting the product or service data comprises both audible output and visual display output for accessibility compliance.

4. The method of claim 1, wherein the secure transaction engine complies with healthcare data privacy regulations including HIPAA and GDPR, and the accessibility-adapted confirmation comprises haptic feedback, enlarged text, or auditory confirmation.

5. The method of claim 1, wherein the voice interface is integrated into a smart device, wearable device, or telemedicine terminal, and the transaction comprises ordering prescription medication, scheduling a diagnostic service, or purchasing a medical device.

6. A system for multilingual medical voice commerce, comprising:
a voice interface configured to receive a spoken request in a first language;
a natural language processing module configured to process the spoken request and determine at least one medical-related product or service;
a multilingual output module configured to present product or service data to the user in a selected language;
a secure transaction engine configured to execute a transaction for the selected product or service; and
an accessibility module configured to provide an accessibility-adapted confirmation of the completed transaction.

7. The system of claim 6, further comprising a medical commerce database storing product or service data and associated metadata, wherein the multilingual output module supports simultaneous translation into at least two target languages.

8. The system of claim 6, wherein the accessibility module includes features for users with visual, auditory, or motor impairments, and the voice interface is embedded in a telehealth platform to support in-session medical commerce transactions.

9. The system of claim 6, wherein the secure transaction engine is integrated with payment gateways supporting healthcare-specific billing codes.

10. A non-transitory computer-readable medium storing instructions which, when executed by a processor, perform the method of claim 1.

11. A computer-implemented method for providing multilingual telehealth consultations with integrated medical commerce functionality, the method comprising:
receiving a spoken request from a user in a first language via a voice interface;
translating the spoken request into a target language used by a healthcare provider;
initiating a real-time telehealth session between the user and the healthcare provider;
retrieving and displaying patient-specific data from an electronic health record (EHR) system to the healthcare provider;
receiving, during the telehealth session, at least one medical recommendation;
converting the recommendation into a corresponding medical commerce transaction;
executing the transaction through a secure transaction engine; and
providing an accessibility-adapted confirmation of the transaction to the user.

12. The method of claim 11, wherein the real-time telehealth session comprises secure, HIPAA-compliant communication with real-time speech-to-speech translation between the user and the healthcare provider in at least two languages.

13. The method of claim 11, wherein patient-specific data comprises laboratory results, diagnostic images, or medication history, and the medical recommendation is automatically parsed into product identifiers for commerce transaction processing.

14. The method of claim 11, further comprising automatically scheduling follow-up appointments and providing accessibility-adapted confirmation via the user's preferred output mode.

15. The method of claim 11, wherein translating the spoken request comprises real-time speech-to-speech translation between the user and the healthcare provider in at least two languages.

16. The method of claim 11, wherein the real-time telehealth session is conducted over a secure, HIPAA-compliant communication channel.

17. The method of claim 11, wherein the retrieved patient-specific data comprises laboratory results, diagnostic images, or medication history.

18. The method of claim 11, wherein the at least one medical recommendation is automatically parsed into product identifiers for commerce transaction processing.

19. The method of claim 11, further comprising automatically scheduling follow-up appointments based on the healthcare provider's recommendation.

20. The method of claim 11, wherein the accessibility-adapted confirmation comprises providing both an audible confirmation and a written confirmation via a user's preferred output mode.
